(19) United States
(12) Patent Application Publication
(10) Pub. No.: US 2026/0246197 A1
(43) Pub. Date: Aug. 20, 2026

(54) CONNECTOR ASSEMBLY

(71) Applicant: Aptiv Technologies AG, Schaffhausen (CH)

(72) Inventors: Fabrice DEMOMENT, NOGENT LE ROI (FR); Frederic BELLIARD, TREMBLAY-LES-VILLAGES (FR); Andre-Michael LUIS, VERSAILLES (FR)

(21) Appl. No.: 19/541,515

(22) Filed: Feb. 17, 2026

(30) Foreign Application Priority Data
Feb. 17, 2025 (EP) 25158404.1

(51) Int. Cl. H01R 13/52; H01R 13/502; H01R 13/514; H01R 13/627; H01R 13/631; H01R 13/64; H01R 13/6581

(52) U.S. Cl. CPC H01R 13/5219; H01R 13/502; H01R 13/514; H01R 13/5202; H01R 13/6275; H01R 13/631; H01R 13/64; H01R 13/6581

(57) ABSTRACT

A connector assembly includes a mechanical interface with a flat upper face having fixing holes and a cable end passage, and a header with an electrical connection interface and a flange. The flange has through-holes for receiving fastening screws to secure the header to the mechanical interface, and a peripheral groove surrounding the cable end passage and the through-holes. A peripheral seal is housed in the groove to ensure watertightness between the header and the mechanical interface. The mechanical interface has a recess with a flat bottom and a peripheral wall, which receives the flange and compresses the peripheral seal, providing a watertight connection with a height of the peripheral wall greater than 0.5 mm.

### CROSS-REFERENCE TO RELATED APPLICATION

This application claims the benefit of and priority to European Application No. 25158404.1 filed with the European Patent Office on February 17, 2025, the contents of which are incorporated by reference herein.

### TECHNICAL FIELD

The present disclosure generally relates to a connector assembly.

### BACKGROUND

Connector assemblies are used, in particular, in high-power applications requiring high reliability in demanding environments. To this end, these connector assemblies are designed to be dustproof and waterproof.

Known connector assemblies include a mechanical interface through which the electrical ends of cables pass, and a header fixed without any degree of freedom to the mechanical interface. The mechanical interface is flat and also has fixing holes. The header includes a flange with a lower flat face directly supported on the mechanical interface. The flat face includes a groove encircling the openings through which the electrical ends of cables pass through the mechanical interface. To ensure waterproofing, a seal is housed in this groove. Outside this seal, the header has through-holes, each of which receives a fastening screw that is screwed into the mechanical interface to secure the header to the mechanical interface without any degree of freedom.

For high-power applications, the dimensions of the header are significant. For example, typically, the external dimensions of the flange of the header exceed 50 mm by 50 mm.

Such connector assemblies are sometimes subjected to high-pressure water jets, for example, during car washing. In such cases, it has been observed that such high-pressure jets can compromise the waterproofing of the connector assembly.

In this context, it is desirable to improve the resistance of known connector assemblies to high-pressure jets.

### SUMMARY

In some aspects, the techniques described herein relate to a connector assembly including a mechanical interface having a flat upper face in which several fixing holes and at least one cable end passage are formed, the fixing holes surrounding the at least one cable end passage, for each fixing hole, a fastening screw housed in the fixing hole; a header including an electrical connection interface configured to be alternately connected to and disconnected from a corresponding electrical connection interface of another removable connector assembly, the electrical connection interface being connectable to an electrical cable end that goes through the cable end passage; a flange including opposite each fixing hole, a corresponding through-hole receiving the fastening screw to secure the header to the upper face of the mechanical interface with no degree of freedom, a flat lower face in direct mechanical contact with the flat upper face of the mechanical interface, and a peripheral groove formed in the flat lower face of the flange, the peripheral groove surrounding each cable end passage and each through-hole being located on a side of the groove opposite the side where each cable end passage is located; and a peripheral seal housed in the peripheral groove to ensure watertightness between the header and the mechanical interface, wherein the mechanical interface includes a recess formed in its flat upper face and in which the flange is received, the recess including a flat bottom in which each fixing hole and each cable end passage open and against which the peripheral seal is compressed, and a peripheral wall facing the flange and completely surrounding the flange, the peripheral wall extending only from the flat bottom to the flat upper face of the mechanical interface, wherein a height of the peripheral wall is greater than 0.5 mm.

In some aspects, the techniques described herein relate to a connector assembly, wherein a clearance between the peripheral wall of the recess and the flange is greater than 0.5 mm and equal to or less than the height of the peripheral wall.

In some aspects, the techniques described herein relate to a connector assembly, wherein the height of the peripheral wall is greater than 1 mm.

In some aspects, the techniques described herein relate to a connector assembly, wherein the height of the peripheral wall is less than 3 mm or less than 5 mm.

In some aspects, the techniques described herein relate to a connector assembly, wherein the connector assembly includes at least one cable end passing through the cable end passage, one end of which is electrically connected to the electrical connection interface.

In some aspects, the techniques described herein relate to a connector assembly, wherein transversal dimensions of the flange are greater than 50 mm by 50 mm.

### BRIEF DESCRIPTION OF THE DRAWINGS

Other features, details, and advantages of the disclosure will become more apparent from the detailed illustrative description given hereafter with respect to the drawings on which:

FIG. 1 is an isometric view of a connector assembly according to some embodiments.

FIG. 2 is a cross-section view, of the connector assembly of FIG. 1 according to some embodiments.

FIG. 3 is an isometric view of a mechanical interface of the connector assembly of FIG. 1 according to some embodiments.

FIG. 4 is a top view of the mechanical interface of FIG. 3 according to some embodiments.

FIGS. 5 and 6 are partial cross-section views of the connector assembly of FIG. 1 according to some embodiments.

### DETAILED DESCRIPTION

In the figures, the same references are used to designate the same elements.

In the rest of this description, characteristics and functions well known to those skilled in the art are not described in detail.

The figures are oriented relative to an orthogonal XYZ reference frame, where the X and Y directions are horizontal and the Z direction is vertical. Terms such as “above,” “below,” “top,” “bottom,” “upper,” and “lower” are defined with respect to the Z direction.

The expression “an element made of material A” or the expression “an element of material A” means that material A constitutes 90% or 95% of the mass of this element.

"High-power" refers to the combination of high voltage and high current.

"High voltage" refers to a direct voltage exceeding 100 Vdc and typically less than 3000 Vdc.

"High current" refers to a direct current exceeding 50 A and typically less than 1000 A.

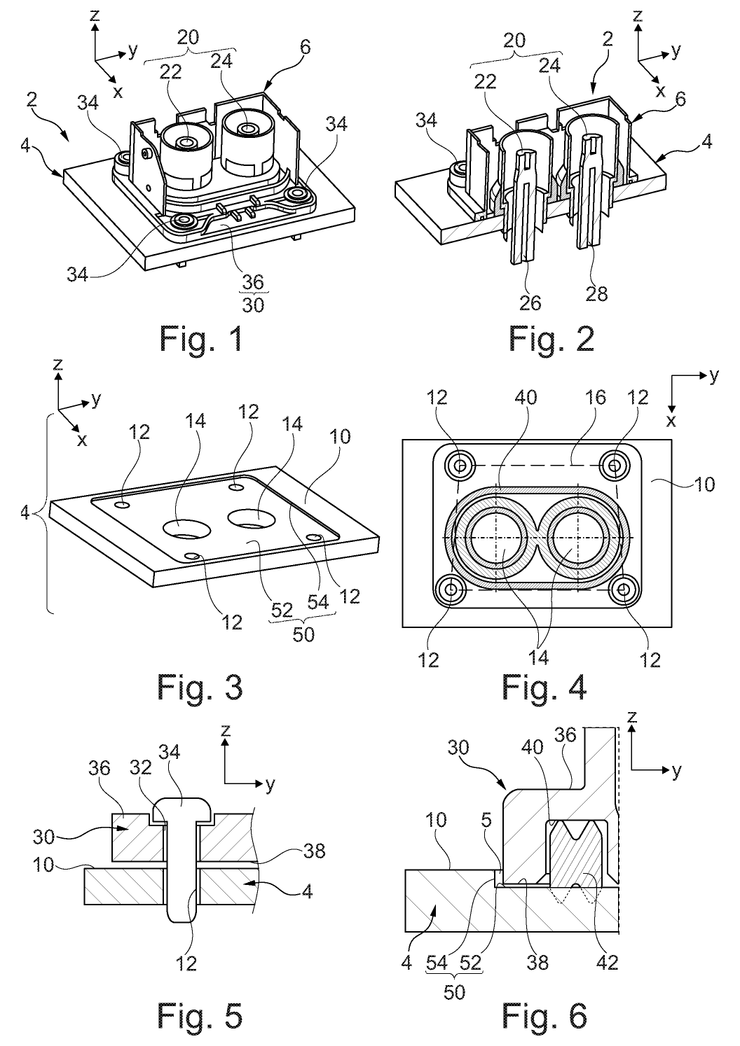

FIGS. 1 and 2 depict the male part of a connector assembly intended for the electrical connection of a high-power DC electrical device. The high-power DC electrical device is, for example, a DC-DC converter, a high-voltage battery, or an electric motor of a vehicle such as an automobile.

The connector assembly 2 is designed to operate with high power and in demanding environments. For example, the connector assembly 2 withstands, without degradation, direct voltages up to 1000 Vdc and direct currents up to 350 A. The connector assembly 2 is dustproof and waterproof. For example, the connector assembly 2 has a protection rating of IP equal to or greater than IP67.

The connector assembly 2 includes a mechanical interface 4 and a header 6 fixed without any degree of freedom to this mechanical interface 4. The mechanical interface 4 is shown in more detail in FIGS. 3 and 4.

The mechanical interface 4 is a plate located on the surface of the electrical device. This plate may be part of the outer wall of the electrical device or an added plate on the outer wall of the electrical device. In this embodiment, the mechanical interface 4 is in the form of a rectangular plate intended to be fixed, without any degree of freedom, on the outer wall of the electrical device.

The mechanical interface 4 is typically made of metal, for example, aluminum.

Here, the horizontal section of the mechanical interface 4 is rectangular. The width and length of the mechanical interface 4 are generally greater than 50 mm and usually less than 200 mm. The thickness of the mechanical interface 4 is between 5 mm and 10 mm.

The mechanical interface 4 comprises an upper flat face 10 (FIG. 3) into which fixing holes 12 and cable end passages 14 (FIG. 3) open.

For example, here, the fixing holes 12 are threaded holes. In this embodiment, the mechanical interface 4 includes four fixing holes 12, each located near a corner of a horizontal rectangle. The diameter of the fixing holes is, for example, between 3 mm and 15 mm. Here, the diameter of the fixing holes is 6 mm.

Each passage 14 extends entirely through the mechanical interface 4. Here, each passage 14 is a through cylindrical hole. In this embodiment, the cross-sectional shape of the passages 14 is circular. The diameter of each passage 14 is adapted to receive an end of an electrical cable whose cross-sectional area is, for example, between 10 mm² and 200 mm², and most often between 35 mm² and 100 mm². For this purpose, the diameter of the passages 14 is, for example, between 15 mm and 30 mm. Here, the diameter of the passages 14 is 22.35 mm.

The passages 14 are located inside a horizontal polygon 16 (FIG. 4) whose vertices coincide with the vertical axes of the fixing holes. The passages 14 are spaced sufficiently from this polygon 16 to allow for a seal that completely surrounds the passages 14 and around which the fixing holes 12 are located. For example, for this purpose, each passage 14 is at least 10 mm away from the nearest fixing hole 12.

In this embodiment, the mechanical interface 4 includes two passages 14.

The header 6 comprises, in its upper part, a male electrical connection interface 20 capable of being electrically connected to and alternately disconnected from a corresponding female electrical connection interface of a corresponding female connector assembly not shown in the figures. To this end, the male interface 20 and the corresponding female interface are designed to mechanically interlock with each other. When these electrical interfaces are interlocked, the electrical connection is established. Conversely, when these electrical interfaces are mechanically separated from each other, the electrical connection is interrupted.

Here, the interface 20 includes two terminals 22, 24 (FIG. 1, 2), each intended to match with a corresponding hole of the female interface.

The terminals 22, 24 are permanently connected to the ends of electrical cable ends, respectively, 26, 28 (FIG. 2). Here, the cable ends 26, 28 pass through the mechanical interface 4, each through one of the respective passages 14.

In its lower part, the header 6 includes a flange 30 that is directly mechanically supported on the upper flat face 10 of the mechanical interface 4. Here, the flange 30 is primarily parallelepipedal. The width and length of the flange 30 are generally greater than 50 mm and usually less than 150 mm. Here, the width of the flange 30 is between 60 mm and 80 mm, and its length is between 80 mm and 100 mm. The thickness of the flange 30 is between 2 mm and 10 mm, for example. When the flange 30 is supported on the flat face 10, the flange 30 covers only part of the flat face 10 so that flange 30 is surrounded by an uncovered strip of the flat face 10. This strip is typically several millimeters wide. For example, the uncovered strip is wider than 3 mm or 5 mm or 10 mm.

The flange 30 includes, for each fixing hole 12, a corresponding through-hole 32 (FIG. 5). Each through-hole 32 receives a fastening screw 34 (FIG. 1, 5) whose shaft is screwed into one of the fixing holes 12. The heads of the fastening screws 34 rest on an upper face 36 (FIG. 1, 5) of the flange 30 to hold a lower face 38 (FIG. 5, 6) of the flange 30 firmly pressed against the upper face 10 of the mechanical interface 4.

The lower face 38 of the flange 30 is the face of the flange 30 located opposite its upper face 36 and is directly mechanically supported on the upper face 10 of the mechanical interface 4. Typically, the lower face 38 is primarily flat and horizontal and extends all around the passages 14 and between these passages 14 and the fixing holes 12.

To ensure waterproofing between the header 6 and the mechanical interface 4, a peripheral groove 40 (FIG. 6) is cut into the lower face 38. The location of this groove 40 relative to the passages 14 and the fixing holes 12 is shown in FIG. 4. This groove 40 completely encircles the passages 14. This groove 40 is also always located between the passages 14 and the fixing holes 12. In other words, the passages 14 are on the inner side of the groove 40, while the fixing holes 12 are on the outer side of this groove 40. Here, at least 80% or 90% of the orthogonal projection of the groove 40 onto the upper face 10 is within the polygon 16.

The connector assembly 2 includes a seal 42 (FIG. 6) received inside the groove 40. When the screws 34 are tightened, the seal 42 is compressed against the upper face 10 and prevents water from seeping between the mechanical interface 4 and the flange 30 to reach one of the passages 14. For this purpose, the seal 42 extends continuously all around the passages 14 and completely fills the groove 40 when compressed against the upper face 10.

A significant part of the header 6, particularly the flange 30, is typically made of plastic.

When the screws 34 are tightened, the seal 42 exerts upward pressure on the lower face 38. It has been observed that this upward pressure can deform the flange 30, particularly raising the outer edges of the lower face 38 such that there is a gap between the outer edges of the face 38 and the upper face 10. In these conditions, during high-pressure cleaning, water projected at high speed directly penetrates this gap and violently strikes the seal 42. This damages the seal 42 and thus compromises the waterproofing of the connector assembly 2.

To address this problem, here, a recess 50 is cut into the upper face 10 of the mechanical interface 4 to receive the flange 30. This recess 50 is delimited, on the lower side, by a flat horizontal bottom 52 (FIG. 3, 6) and, on the sides, by a vertical peripheral wall 54 (FIG. 3, 6). The fixing holes 12 and passages 14 open into this bottom 52.

The dimensions of the flat bottom 52 are slightly larger than the horizontal dimensions of the flange 30 so that the flange 30 rests solely on this bottom 52. The peripheral wall 54 faces the flange 30 and extends continuously around the flange 30. The height of the wall 54 is constant and greater than 0.5 mm, and in some embodiments greater than 1 mm. Generally, the height of the wall 54 is also less than 3 mm or 5 mm. The vertical clearance J (FIG. 6) between the wall 54 and the vertical face of the flange 30 facing it is between 0.5 mm and h₅₄, where h₅₄ is the height of the wall 54. For example, the clearance J is less than 2 mm or 1 mm.

In these conditions, when a high-pressure jet is directed toward the corner between the flange 30 and the mechanical interface 4, it cannot directly reach the gap between the lower face 38 and the bottom 52. It must first penetrate the vertical clearance J, then sink vertically to the bottom 52, and then make a 90° turn to penetrate the gap between the lower face 38 and the bottom 52. The fact that the high-pressure jet is forced to make a 90° turn before penetrating the gap between the face 38 and the bottom 52 to then reach the seal 42 breaks the speed of the high-pressure jet. As a result, the power of the high-pressure jet is considerably reduced when it reaches the seal 42, so it hardly damages the seal 42 anymore. The waterproofing of the connector assembly 2 is therefore preserved even when exposed to a high-pressure jet.

In some embodiments, the fixing holes 12 are not threaded. In this case, the fixing screw 34 is a bolt whose threaded shaft passes through the fixing hole 12, and a nut is screwed onto its end.

The number of fixing holes 12 provided in the mechanical interface 4 may be two, three, or greater than four.

The number of passages 14 provided in the mechanical interface 4 may be one or equal to or greater than three or four.

The mechanical interface 4 may be made of materials other than metal.

Other designs of the electrical connection interface 20 are possible. For example, the number of terminals 22, 24 in the interface 20 may be one or more than two. In this case, the number of passages 14 and the number of electrical cable ends are correspondingly adjusted.

Everything described in the specific case where the electrical connection interface 20 is a male interface applies to the case where the interface 20 is a female electrical connection interface.

Several of the embodiments described above can be combined into a single embodiment.

While the invention has been described with reference to an exemplary embodiment(s), it may be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It may also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It may also be understood that the term “and/or” as used herein refers to and encompasses any and all possible combinations of one or more of the associated listed items. It may be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. Connector assembly comprising:
a mechanical interface having a flat upper face in which several fixing holes and at least one cable end passage are formed, the fixing holes surrounding the at least one cable end passage, for each fixing hole, a fastening screw housed in the fixing hole;
a header comprising:
an electrical connection interface configured to be alternately connected to and disconnected from a corresponding electrical connection interface of another removable connector assembly, the electrical connection interface being connectable to an electrical cable end that goes through the cable end passage;
a flange comprising:
opposite each fixing hole, a corresponding through-hole receiving the fastening screw to secure the header to the upper face of the mechanical interface with no degree of freedom,
a flat lower face in direct mechanical contact with the flat upper face of the mechanical interface, and
a peripheral groove formed in the flat lower face of the flange, tthe peripheral groove surrounding the at least one cable end passage and each through-hole being located on a side of the groove opposite the side where each cable end passage is located; and
a peripheral seal housed in the peripheral groove to ensure watertightness between the header and the mechanical interface, wherein the mechanical interface comprises a recess formed in its flat upper face and in which the flange is received, the recess comprising:
a flat bottom in which each fixing hole and each cable end passage open and against which the peripheral seal is compressed, and
a peripheral wall facing the flange and completely surrounding the flange, the peripheral wall extending only from the flat bottom to the flat upper face of the mechanical interface, wherein a height of the peripheral wall is greater than 0.5 mm.

2. The connector assembly of claim 1, wherein a clearance between the peripheral wall of the recess and the flange is greater than 0.5 mm and equal to or less than the height of the peripheral wall.

3. The connector assembly according to claim 1, wherein the height of the peripheral wall is greater than 1 mm.

4. The connector assembly according to claim 1, wherein the height of the peripheral wall is less than 3 mm or less than 5 mm.

5. The connector assembly according to claim 1, wherein the connector assembly comprises at least one cable end passing through the cable end passage, one end of which is electrically connected to the electrical connection interface.

6. The connector assembly according to claim 1, wherein transversal dimensions of the flange are greater than 50 mm by 50 mm.
